(19) United States
(12) Patent Application Publication
(10) Pub. No.: US 2024/0377528 A1
(43) Pub. Date: Nov. 14, 2024

(54) STATE DETERMINATION DEVICE, STATE DETERMINATION METHOD, AND RECORDING MEDIUM HAVING STATE DETERMINATION PROGRAM STORED THEREON

(71) Applicant: NEC Corporation, Minato-ku, Tokyo (JP)

(72) Inventors: Nana Jumonji, Tokyo (JP); Takakazu Ishii, Tokyo (JP); Hiromichi HIRATA, Tokyo (JP); Shouhei OHNO, Tokyo (JP)

(73) Assignee: NEC Corporation, Minato-ku, Tokyo (JP)

(21) Appl. No.: 18/687,917

(22) PCT Filed: Sep. 15, 2021
(86) PCT No.: PCT/JP2021/033942

§ 371 Date: Feb. 29, 2024

(51) Int. Cl. G01S 13/90; G01S 13/95

(52) U.S. Cl. CPC G01S 13/9094; G01S 13/955

(57) ABSTRACT

A state determination device includes: an acquisition unit for analyzing observation information near the surface of the ground by a satellite-borne synthetic aperture radar (SAR) to acquire a state measurement value indicating a state near the surface of the ground; a determination unit for determining whether a relation between a value of an index with which predetermined regularity regarding the state may be present and the state measurement value or a relation between a state estimation value near the surface of the ground that is estimated from a value of the index and the state measurement value satisfies the predetermined regularity; and an output unit that when the relation between the value of the index and the state estimation value or the relation between the state estimation value and the state measurement value does not satisfy the predetermined regularity, outputs determination result information indicating that the state is abnormal.

### TECHNICAL FIELD

The present invention relates to a state determination device, a state determination method, and a recording medium storing a state determination program.

### BACKGROUND ART

In recent years, various kinds of data on the earth have been collected using remote sensing, which is a technology for observing the earth by an observation device (sensor) mounted on an artificial satellite. As an example of this remote sensing, a state of the area near the earth surface is analyzed from observation information obtained by observing the area near the earth surface using a synthetic aperture radar (hereinafter referred to as SAR) mounted on an artificial satellite. A technique for accurately determining a state of the area near the earth surface from observation information based on SAR is expected.

As a technique related to such a technique, PTL 1 discloses an abnormality degree determination system that acquires a displacement amount of an object on a ground surface measured using SAR and determines an abnormality degree of the object using the displacement amount and an abnormality determination criterion.

In addition, PTL 2 discloses a SAR image analysis system that holds a plurality of pieces of SAR image data of different acquisition times, obtained by observing an observation range, and sensor observation data of a sensor device group that observes known coordinates of the observation range. This system performs interference analysis on a plurality of SAR image data to acquire interference analysis result data, and extracts a correlation between a displacement amount of each analysis point included in the interference analysis result data and each observation data for each observation coordinate included in the sensor observation data. Then, this system estimates the generation factor of the displacement amount of each analysis point included in the interference analysis result data based on the presence or absence, collapse, or the like of a correlation, and extracts at least the type of repair work related to the estimation result with respect to a point where the displacement amount of the analysis point of the interference analysis result data is large or a structure or topography including the analysis point.

### CITATION LIST

### Patent Literature

PTL 1: JP 2017-215248 A
PTL 2: JP 2020-020740 A

### SUMMARY OF INVENTION

### Technical Problem

In general, there may be some regularity between the state of the earth surface indicated by the observation information obtained by observing the area near the earth surface by SAR and various indices (factors). For example, it is assumed that the subsidence of the ground at a certain place is observed by the observation information. Then, when continuous ground subsidence with the lapse of time has been observed at the place, and the newly observed ground subsidence amount falls within the range assumed from the previously observed ground subsidence amount (that is, the regularity is satisfied), it can be said that the ground state is normal. On the other hand, when the newly observed ground subsidence amount deviates from the range assumed from the previously observed ground subsidence amount (that is, does not satisfy regularity), it is estimated that an abnormality has occurred in the ground. In this case, for example, it is an error to determine that an abnormality has occurred in the ground simply based on the occurrence of ground subsidence in the ground of the observation target.

In addition, it is assumed that a displacement of a position of an observation point included in a structure (a building, a bridge, or the like) present on a ground surface is observed based on observation information obtained by observing the structure by SAR. Since a substance such as metal constituting the structure expands and contracts depending on the temperature, there is a regularity between the displacement amount of the observation point and the temperature. Therefore, it is estimated that the state of the structure is normal when the displacement amount of the newly observed observation point satisfies the regularity, and the state of the structure is abnormal when the displacement amount of the newly observed observation point does not satisfy the regularity. In this case, for example, if it is simply determined whether the state of the structure is normal from the displacement amount of the observation point without considering the temperature, an error may occur in the determination.

That is, there is a problem that, when determining whether the state of the area near the earth surface is abnormal from the observation information observed by the SAR, accurate determination cannot be performed unless the above-described regularity at the normal time is considered. PTLs 1 and 2 do not particularly mention such a problem.

A main object of the present invention is to more accurately determine whether a state of the area near the earth surface is abnormal from observation information observed by SAR.

### Solution to Problem

A state determination device according to an aspect of the present invention includes: an acquisition means configured to acquire a state measurement value indicating a state of an area near an earth surface by analyzing observation information near the earth surface by a satellite-borne synthetic aperture radar; a determination means configured to determine whether a relationship between the state measurement value and a value of an index in which a predetermined regularity may exist between the index and the state or a relationship between the state measurement value and a state estimation value near the earth surface estimated from the value of the index satisfies the predetermined regularity; and an output means configured to output determination result information indicating that the state is abnormal when the relationship between the value of the index and the state measurement value or the relationship between the state estimation value and the state measurement value does not satisfy the predetermined regularity.

In another aspect of achieving the above object, a state determination method according to an aspect of the present invention causes an information processing device to execute: acquiring a state measurement value indicating a state of an area near an earth surface by analyzing observation information near the earth surface by a satellite-borne synthetic aperture radar; determining whether a relationship between the state measurement value and a value of an index in which a predetermined regularity may exist between the index and the state or a relationship between the state measurement value and a state estimation value near the earth surface estimated from the value of the index satisfies the predetermined regularity; and outputting determination result information indicating that the state is abnormal when the relationship between the value of the index and the state measurement value or the relationship between the state estimation value and the state measurement value does not satisfy the predetermined regularity.

Furthermore, from still another aspect of achieving the above object, a state determination program according to an aspect of the present invention causes a computer to execute: an acquisition process of acquiring a state measurement value indicating a state of an area near an earth surface by analyzing observation information near the earth surface by a satellite-borne synthetic aperture radar; a determination process of determining whether a relationship between the state measurement value and a value of an index in which a predetermined regularity may exist between the index and the state or a relationship between the state measurement value and a state estimation value near the earth surface estimated from the value of the index satisfies the predetermined regularity; and an output process of outputting determination result information indicating that the state is abnormal when the relationship between the value of the index and the state measurement value or the relationship between the state estimation value and the state measurement value does not satisfy the predetermined regularity.

Furthermore, the present invention can also be implemented by a non-volatile computer-readable recording medium storing the state determination program (computer program).

### Advantageous Effects of Invention

According to the present invention, it is possible to obtain a state determination device and the like that more accurately determine whether a state of the area near the earth surface is abnormal from observation information observed by SAR.

### BRIEF DESCRIPTION OF DRAWINGS

FIG. 1 is a block diagram illustrating a configuration of a state determination device 10 according to a first example embodiment of the present invention.

FIG. 2 is a diagram illustrating a first example in which the state determination device 10 according to the first example embodiment of the present invention determines whether a state of the area near the earth surface indicated by a state measurement value 151 is normal.

FIG. 3 is a diagram illustrating a second example in which the state determination device 10 according to the first example embodiment of the present invention determines whether a state of the area near the earth surface indicated by the state measurement value 151 is normal.

FIG. 4 is a diagram illustrating an input to a calculation criterion 152 and an output from the calculation criterion 152 when the calculation criterion 152 according to the first example embodiment of the present invention is an estimation model that has learned a relationship between an index in the past and a state of the area near the earth surface.

FIG. 5 is a diagram illustrating an example of a mode in which determination result information 155 according to the first example embodiment of the present invention is displayed on a display screen 200 of a management terminal device 20.

FIG. 6 is a flowchart illustrating an operation of the state determination device 10 according to the first example embodiment of the present invention.

FIG. 7 is a block diagram illustrating a configuration of a state determination device 30 according to a second example embodiment of the present invention.

FIG. 8 is a block diagram illustrating a configuration of an information processing device 900 capable of achieving a state determination device according to each example embodiment of the present invention.

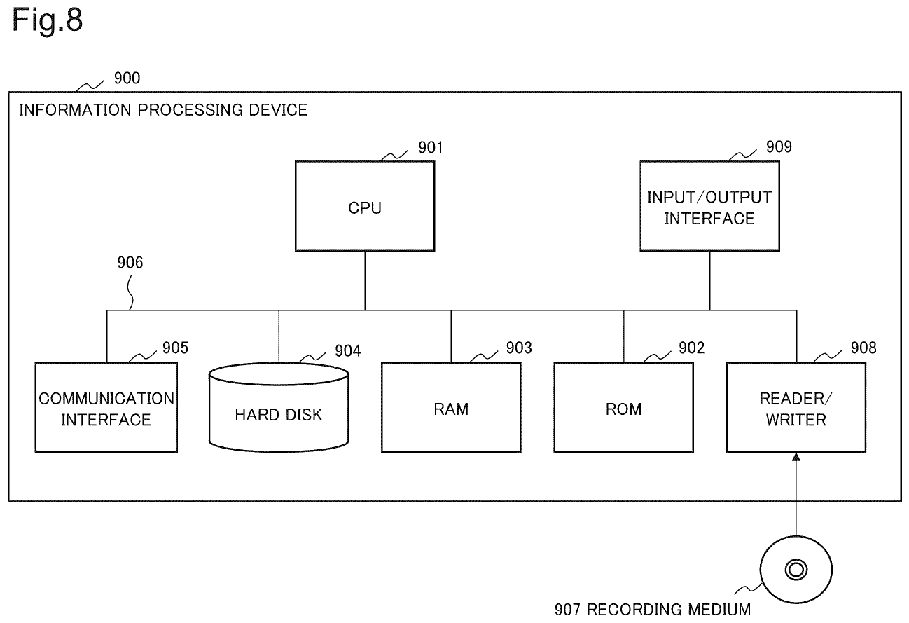

### EXAMPLE EMBODIMENT

Hereinafter, example embodiments of the present invention will be described in detail with reference to the drawings.

### First Example Embodiment

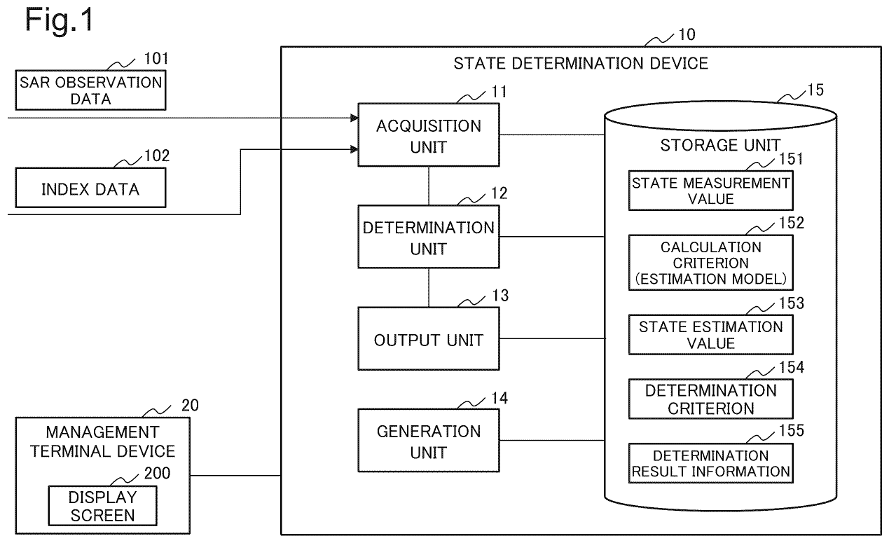

FIG. 1 is a block diagram illustrating a configuration of a state determination device 10 according to a first example embodiment of the present invention. The state determination device 10 according to the present example embodiment is a device that determines whether a state of the area near the earth surface is abnormal from SAR observation data 101 (observation information) obtained by observing the area near the earth surface by SAR.

The management terminal device 20 is communicably connected to the state determination device 10. The management terminal device 20 is, for example, a personal computer or another information processing device used when a user who uses the state determination device 10 inputs information to the state determination device 10 or confirms information output from the state determination device 10. The management terminal device 20 includes a display screen 200 that displays the information output from the state determination device 10.

The state determination device 10 includes an acquisition unit 11, a determination unit 12, an output unit 13, a generation unit 14, and a storage unit 15. The acquisition unit 11, the determination unit 12, the output unit 13, and the generation unit 14 are examples of an acquisition means, a determination means, an output means, and a generation means in order.

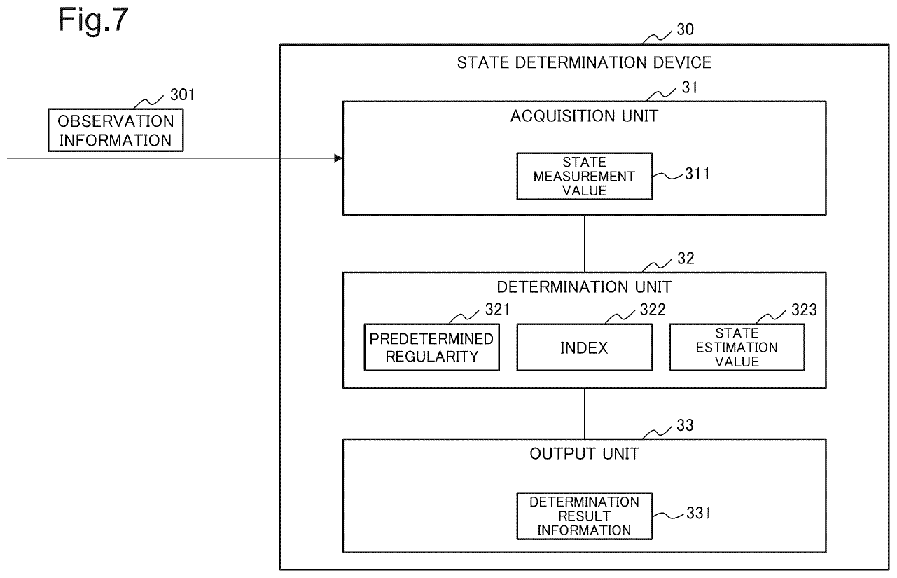

The storage unit 15 is, for example, a storage device such as a random access memory (RAM) or a hard disk 904 described later with reference to FIG. 7. The storage unit 15 stores a state measurement value 151, a calculation criterion 152, a state estimation value 153, a determination criterion 154, and determination result information 155. Details of these pieces of information stored in the storage unit 15 will be described later.

The acquisition unit 11 acquires the SAR observation data 101 and the index data 102 from an external device. The external device may be, for example, the management terminal device 20 or an information processing device such as a server having a database function.

As described above, the SAR observation data 101 is data obtained by observing the area near the earth surface by SAR. The SAR observation data 101 includes, for example, an image obtained by imaging the area near the earth surface by an electromagnetic wave of a predetermined wavelength. The image includes information indicating a distance to the area near the earth surface which is an observation target. The SAR observation data 101 may include, for example, data of the amount of moisture contained in the earth surface. The amount of moisture can be observed, for example, from the backscattering coefficient of the electromagnetic wave observed in the measurement of the distance to the earth surface. The area near the earth surface which is an observation target includes a ground surface or a structure existing on the ground surface. The structure includes, for example, a building such as a building, a bridge, or the like.

The acquisition unit 11 analyzes the acquired SAR observation data 101 to acquire (obtain) the state measurement value 151 indicating the state of the area near the earth surface. The state measurement value 151 indicates, for example, a displacement amount of a ground surface or a position of a structure existing on the ground surface due to a rise or subsidence of the ground. Since a method for obtaining the state measurement value 151 by analyzing the SAR observation data 101 is well known, a detailed description thereof will be omitted in the present example embodiment.

The acquisition unit 11 stores the acquired state measurement value 151 in the storage unit 15 together with the SAR observation data 101.

The index data 102 is, for example, data indicating at least one of natural factors and human factors that affect the state of the area near the earth surface indicated by the state measurement value 151.

Specific examples of the natural factors described above include a temperature, a precipitation amount, a groundwater amount, and a geological feature near the earth surface which is an observation target. Since a substance such as metal constituting a structure existing on the ground surface expands and contracts depending on temperature, the displacement amount of the position of the observation point in the structure has regularity with the temperature. Therefore, the temperature is an index that affects the state of the area near the earth surface indicated by the state measurement value 151. In addition, for example, the precipitation amount, the groundwater amount, the geological feature, and the like are indices that affect the ground subsidence indicated by the state measurement value 151. The acquisition unit 11 can acquire, for example, data disclosed by the Meteorological Agency, a research institution, or the like as the index data 102 indicating precipitation amount, groundwater amount, geological feature, or the like.

Specifically, the above-described human factors are, for example, construction on the ground near the earth surface, which is an observation target, traffic volume near the earth surface, and the like. For example, ground subsidence may occur due to shield work performed under the ground which is an observation target, and thus the content of the work on the ground is an index that affects the ground subsidence indicated by the state measurement value 151. In addition, the traffic volume near the earth surface which is an observation target is an index that affects the state of a bridge, a road, or the like existing near the earth surface. The acquisition unit 11 can acquire, for example, data disclosed by a government office, a business operator of road construction, or the like as index data 102 indicating construction on the ground near the earth surface, which is an observation target, traffic volume near the earth surface, and the like.

The information indicated by the index data 102 is not limited to the above-described information. The index data 102 may include information indicating natural factors and human factors different from those described above. The acquisition unit 11 stores the acquired index data 102 in the storage unit 15.

The determination unit 12 calculates the state estimation value 153 near the observation target earth surface from the index data 102 acquired by the acquisition unit 11 using the calculation criterion 152. The determination unit 12 determines whether a predetermined regularity is satisfied (normal) between the calculated state estimation value 153 and the state measurement value 151 acquired by the acquisition unit 11 as described above by using the determination criterion 154. Note that the calculation criterion 152 and the determination criterion 154 are assumed to be given in advance by, for example, an administrator or the like of the state determination device 10.

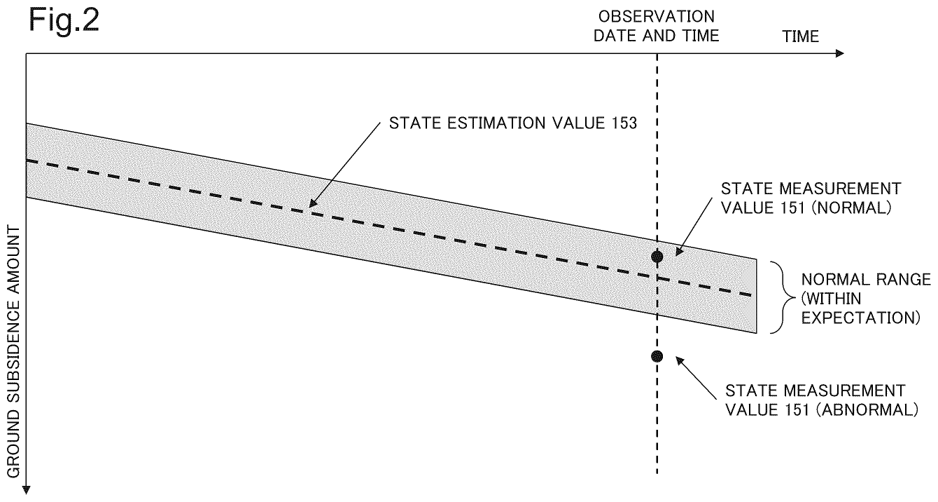

FIG. 2 is a diagram illustrating a first example in which the determination unit 12 according to the present example embodiment determines whether the state of the area near the earth surface indicated by the state measurement value 151 is normal. In the example illustrated in FIG. 2, a natural phenomenon in which the ground sinks at a constant speed with the lapse of time occurs in the ground near the earth surface which is an observation target. In the case of the example illustrated in FIG. 2, the index that affects the subsidence of the ground near the earth surface which is the observation target is the elapsed time from the predetermined time. In this case, the calculation criterion 152 indicates a linear relationship between the elapsed time from the predetermined time and the ground subsidence amount. The determination unit 12 calculates the state estimation value 153 indicated by a dotted line in FIG. 2 based on the calculation criterion 152 indicating the linear relationship.

Since it is assumed that the amount of ground subsidence occurring as a natural phenomenon varies to some extent, in the example illustrated in FIG. 2, a shaded region around the state estimation value 153 is set as a normal range (range within the expectation) regarding the amount of ground subsidence. That is, in this case, the determination criterion 154 indicates that the state of the area near the earth surface which is the observation target is normal when the absolute value of the difference between the state measurement value 151 and the state estimation value 153 is equal to or less than the threshold indicated as the normal range in FIG. 2, and the state of the area near the earth surface which is the observation target is abnormal when the absolute value is larger than the threshold.

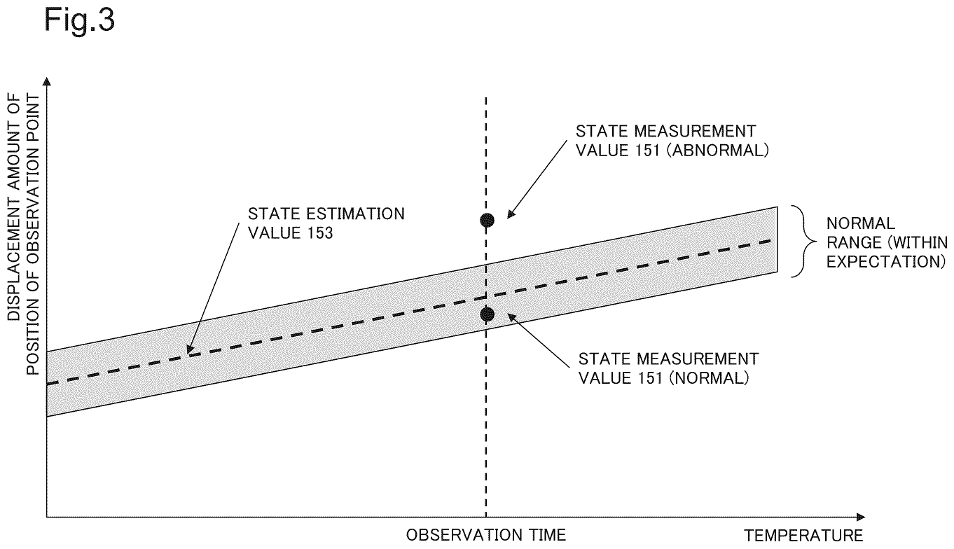

FIG. 3 is a diagram illustrating a second example in which the determination unit 12 according to the present example embodiment determines whether the state of the area near the earth surface indicated by the state measurement value 151 is normal. The example illustrated in FIG. 3 illustrates a relationship between a displacement amount of a position of an observation point and a temperature in a structure existing near the earth surface which is an observation target. In the case of the example illustrated in FIG. 3, the index that affects the displacement of the position of the observation point in the structure existing near the earth surface which is an observation target is the temperature. In this case, the calculation criterion 152 indicates a linear relationship between the temperature and the displacement amount of the position of the observation point. The determination unit 12 calculates the state estimation value 153 indicated by a dotted line in FIG. 3 based on the calculation criterion 152 indicating the linear relationship.

Since it is assumed that the amount of displacement of the position of the observation point generated by expansion and contraction of the structure depending on the temperature varies to some extent similarly to the example illustrated in FIG. 2, in the example illustrated in FIG. 3, a shaded region around the state estimation value 153 is set as a normal range (range within the expectation) regarding the displacement amount of the position of the observation point. That is, in this case, the determination criterion 154 indicates that the state of the area near the earth surface which is the observation target is normal when the absolute value of the difference between the state measurement value 151 and the state estimation value 153 is equal to or less than the threshold indicated as the normal range in FIG. 3, and the state of the area near the earth surface which is the observation target is abnormal when the absolute value is larger than the threshold.

Note that the predetermined regularity between the state of the area near the earth surface which is an observation target and the index is not limited to the linear relationship illustrated in FIGS. 2 and 3. The predetermined regularity may be, for example, a correlation, or may be a relationship in which a state of the area near the earth surface which is an observation target can be simulated based on an index.

The determination criterion 154 is not limited to the criterion using the threshold as illustrated in FIGS. 2 and 3. Furthermore, the determination criterion 154 may be a criterion using a threshold that changes according to the value of the index, instead of a constant threshold. For example, when the degree of variation in the value indicating the state of the area near the earth surface which is the observation target increases as the value of the index increases, the determination criterion 154 may be a criterion using a larger threshold as the value of the index increases.

Furthermore, the determination unit 12 may determine whether the state of the area near the earth surface, which is the observation target, is normal with respect to a plurality of indices (a combination of a plurality of indices) instead of one index as illustrated in the examples of FIGS. 2 and 3. In addition, instead of using the state estimation value 153 obtained from the value of the index, the determination unit 12 may determine whether a predetermined regularity is satisfied between the value of the index itself and the state measurement value 151. However, in this case, it is assumed that the predetermined regularity at the normal time between the value of the index itself and the state measurement value 151 is obtained in advance.

Furthermore, the calculation criterion 152 may be an estimation model that has learned a relationship between a value of an index in the past and a value indicating the state of the area near the earth surface.

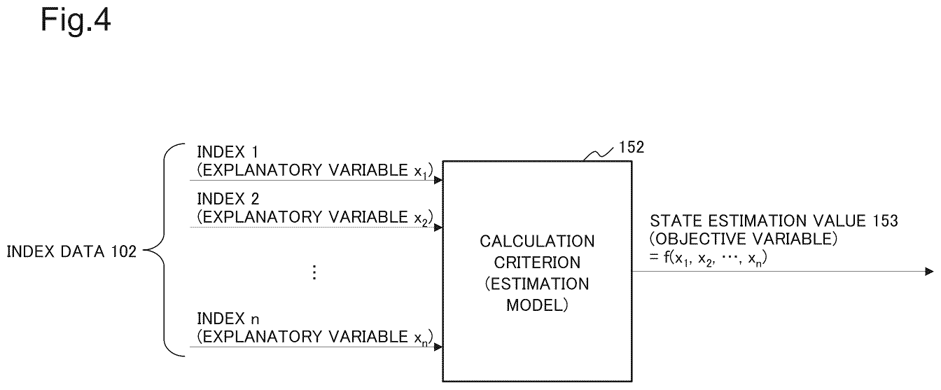

FIG. 4 is a diagram illustrating an input to the calculation criterion 152 and an output from the calculation criterion 152 when the calculation criterion 152 according to the present example embodiment is the above-described estimation model. In the calculation criterion 152 illustrated in FIG. 4, the index 1 indicated by the index data 102 is input as the explanatory variable x₁, the index 2 is input as the explanatory variable x₂, and the index n (n is an arbitrary natural number) is input as the explanatory variable xₙ. Then, the calculation criterion 152 outputs the objective variable f (x₁, x₂, . . . , xₙ) as the state estimation value 153.

The generation unit 14 learns the relationship between the value of the index and the value indicating the state of the area near the earth surface using the values of the indices 1 to n in the past and the state measurement value 151 as teacher data, thereby generating or updating the calculation criterion 152 which is an estimation model. The generation unit 14 may use, for example, a technology such as heterogeneous mixed learning.

The output unit 13 transmits, to the management terminal device 20, determination result information 155 indicating a result of determination by the determination unit 12 as to whether the state of the area near the earth surface which is the observation target is normal or abnormal.

The management terminal device 20 displays the determination result information 155 received from the output unit 13 on the display screen 200.

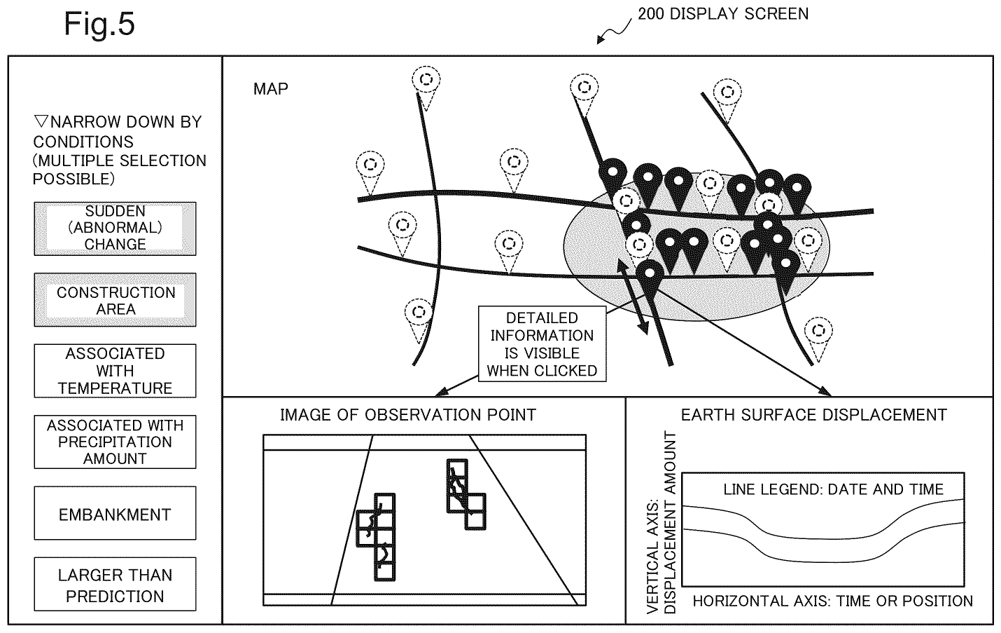

FIG. 5 is a diagram illustrating an example of a mode in which the determination result information 155 according to the present example embodiment is displayed on the display screen 200 of the management terminal device 20. In the example illustrated in FIG. 5, the determination result information 155 includes information indicated by the SAR observation data 101 and the index data 102 in addition to the determination result from the determination unit 12. The output unit 13 controls the management terminal device 20 to display the output determination result information 155 on the display screen 200 as illustrated in FIG. 5.

In FIG. 5, a pin on the map displayed in the upper right window of the display screen 200 indicates an observation point, and a line indicates a road. The left window of the display screen 200 is a screen used when the user selects a condition regarding the state of the area near the earth surface. In the example illustrated in FIG. 5, a “sudden (abnormal) change” and a “construction area” are designated by the user. The management terminal device 20 changes (for example, from white to black) the display color of the pin indicating the observation point where the abnormal change in the state of the area near the earth surface is recognized on the map according to the selection by the user described above, and displays the shaded ellipse indicating the construction area. When any one of the pins (observation points) displayed on the map is selected by the user, the management terminal device 20 displays detailed information on the observation point. In the example illustrated in FIG. 5, the management terminal device 20 displays an image of the area near the observation point and a graph related to the displacement amount of the state of the earth surface of the observation point. The image indicates, for example, a crack or the like generated on the road surface. The graph may be a graph related to a temperature or a precipitation amount. Note that the image near the observation point is assumed to be acquired by a monitoring camera installed near the observation point.

Next, the operation (processing) of the state determination device 10 according to the present example embodiment will be described in detail with reference to the flowchart of FIG. 5.

The acquisition unit 11 acquires the SAR observation data 101 and the index data 102 regarding the area near the earth surface which is an observation target (step S101). The acquisition unit 11 acquires the state measurement value 151 by analyzing the SAR observation data 101 (step S102).

The determination unit 12 calculates the state estimation value 153 based on the index data 102 acquired by the acquisition unit 11 and the calculation criterion 152 (step S103). The determination unit 12 confirms whether the relationship between the calculated state estimation value 153 and the state measurement value 151 satisfies the regularity indicated by the determination criterion 154 (step S104).

When the relationship between the state estimation value 153 and the state measurement value 151 satisfies the regularity indicated by the determination criterion 154 (Yes in step S105), the determination unit 12 generates the determination result information 155 indicating that the state of the area near the earth surface is normal (step S106). When the relationship between the state estimation value 153 and the state measurement value 151 does not satisfy the regularity indicated by the determination criterion 154 (No in step S105), the determination unit 12 generates the determination result information 155 indicating that the state of the area near the earth surface is abnormal (step S107).

The output unit 13 transmits the determination result information 155 to the management terminal device 20 (step S108), and the entire processing ends.

The state determination device 10 according to the present example embodiment can more accurately determine whether the state of the area near the earth surface is abnormal from the observation information observed by the SAR. This is because the state determination device 10 determines whether the predetermined regularity is satisfied between the state measurement value 151 and the state estimation value 153 estimated from the index in which the predetermined regularity exists between the index and the state of the area near the earth surface which is the observation target.

Hereinafter, effects achieved by the state determination device 10 according to the present example embodiment will be described in detail.

In general, there may be some regularity between the state of the earth surface indicated by the observation information obtained by observing the area near the earth surface by SAR and various indices (factors). For example, it is assumed that the subsidence of the ground at a certain place is observed by the observation information. Then, when continuous ground subsidence with the lapse of time has been observed at the place, and the newly observed ground subsidence amount falls within the range assumed from the previously observed ground subsidence amount (that is, the regularity is satisfied), it can be said that the ground state is normal. On the other hand, when the newly observed ground subsidence amount deviates from the range assumed from the previously observed ground subsidence amount (that is, does not satisfy regularity), it is estimated that an abnormality has occurred in the ground. In such a case, when determining whether the state of the area near the earth surface is abnormal from the observation information observed by SAR, there is a problem that accurate determination cannot be performed unless the above-described regularity at the normal time is considered.

In view of such a problem, the state determination device 10 according to the present example embodiment includes the acquisition unit 11, the determination unit 12, and the output unit 13, and operates as described above with reference to FIGS. 1 to 5, for example. That is, the acquisition unit 11 acquires the state measurement value 151 indicating the state of the area near the earth surface by analyzing the SAR observation data 101. The determination unit 12 determines whether a relationship between the state measurement value 151 and the index data 102 in which a predetermined regularity (regularity at the normal time) may exist between the index data and the state or a relationship between the state measurement value 151 and the state estimation value 153 near the earth surface estimated from the index data 102 satisfies the predetermined regularity. Then, when the relationship between the index data 102 and the state measurement value 151 or the relationship between the state estimation value 153 and the state measurement value 151 does not satisfy the predetermined regularity, the output unit 13 outputs the determination result information 155 indicating that the state is abnormal.

That is, since the state determination device 10 according to the present example embodiment determines whether the state of the area near the earth surface is abnormal based on the regularity between the state of the area near the earth surface and the index at the normal time, it is possible to more accurately determine whether the state of the area near the earth surface is abnormal.

In addition, for example, the state determination device 10 may obtain a correlation between the state of the area near the earth surface and the index in normal times (normal times) and determine whether the correlation between the state measurement value 151 and the index is equal to the correlation in normal times. The state determination device determines that the state of the area near the earth surface is normal when the correlation between the state measurement value 151 and the index is equal to the correlation in normal times, and determines that the state of the area near the earth surface is abnormal when the above-described two correlations are different.

In addition, the state determination device 10 according to the present example embodiment further includes the generation unit 14 that generates or updates the calculation criterion 152 indicating the estimation model that has learned the relationship between the index data 102 and the state measurement value 151 in the past. Then, the state determination device 10 obtains the state estimation value 153 using the calculation criterion 152 generated or updated by the generation unit 14, and determines whether the state of the area near the earth surface is abnormal using the obtained state estimation value 153. Therefore, the state determination device 10 can gradually improve the accuracy of the determination as to whether the state of the area near the earth surface is abnormal through the machine learning.

In addition, the index data 102 according to the present example embodiment indicates at least one of natural factors and human factors that affect the state of the area near the earth surface. Then, the natural factor indicates at least one of the temperature, the precipitation amount, the groundwater amount, and the geological feature near the earth surface, and the human factor indicates at least one of construction on the ground near the earth surface and the traffic volume near the earth surface. As described above, since the state determination device 10 determines whether the state of the area near the earth surface is abnormal with respect to various indices that affect the state of the area near the earth surface, it is possible to more accurately determine whether the state of the area near the earth surface is abnormal.

### Second Example Embodiment

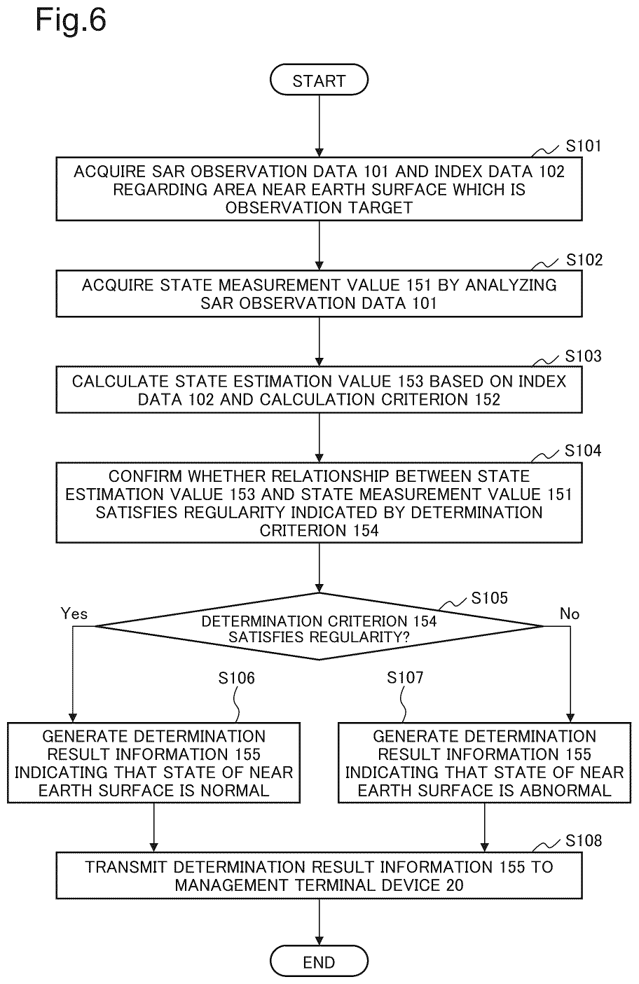

FIG. 6 is a block diagram illustrating a configuration of a state determination device 30 according to a second example embodiment of the present invention. The state determination device 30 includes an acquisition unit 31, a determination unit 32, and an output unit 33. However, the acquisition unit 31, the determination unit 32, and the output unit 33 are examples of an acquisition means, a determination means, and an output means in order.

The acquisition unit 31 acquires a state measurement value 311 indicating the state of the area near the earth surface by analyzing observation information 301 near the earth surface by a satellite-borne synthetic aperture radar (SAR). The observation information 301 is, for example, information similar to the SAR observation data 101 according to the first example embodiment. The state measurement value 311 is, for example, information similar to the state measurement value 151 according to the first example embodiment. The acquisition unit 31 operates similarly to the acquisition unit 11 according to the first example embodiment, for example.

The determination unit 32 determines whether the relationship between the state measurement value 311 and the value of the index 322 in which a predetermined regularity 321 may exist between the index and the state, or the relationship between the state measurement value 311 and the state estimation value 323 near the earth surface estimated from the value of the index 322 satisfies the predetermined regularity 321. The index 322 is, for example, an index indicated by the index data 102 according to the first example embodiment. The predetermined regularity 321 is, for example, regularity as indicated by the calculation criterion 152 according to the first example embodiment. The state estimation value 323 is, for example, information similar to 153 according to the first example embodiment. For example, the determination unit 32 operates similarly to the determination unit 12 according to the first example embodiment.

When the relationship between the value of the index 322 and the state measurement value 311 or the relationship between the state estimation value 323 and the state measurement value 311 does not satisfy the predetermined regularity 321, the output unit 33 outputs the determination result information 331 indicating that the state is abnormal. The determination result information 331 is, for example, information similar to the determination result information 155 according to the first example embodiment. The output unit 33 operates similarly to the output unit 13 according to the first example embodiment, for example.

The state determination device 30 according to the present example embodiment can more accurately determine whether the state of the area near the earth surface is abnormal from the observation information observed by the SAR. This is because the state determination device 30 determines whether the predetermined regularity 321 is satisfied between the state measurement value 311 and the state estimation value 323 estimated from the index 322 in which the predetermined regularity 321 exists between the index and the state of the area near the earth surface which is the observation target.

### Hardware Configuration Example

Each unit in the state determination device 10 illustrated in FIG. 1 or the state determination device 30 illustrated in FIG. 6 in each of the above-described example embodiments can be realized by dedicated hardware (HW) (electronic circuit). In FIGS. 1 and 6, at least the following configuration can be regarded as a functional (processing) unit (software module) of a software program.
the acquisition units 11 and 31,
the determination units 12 and 32,
the output units 13 and 33,
the generation unit 14, and
the storage control function of the storage unit 15.

However, the division of each unit illustrated in these drawings is a configuration for convenience of description, and various configurations can be assumed at the time of implementation. An example of a hardware environment in this case will be described with reference to FIG. 7.

FIG. 7 is a diagram exemplarily describing a configuration of an information processing device 900 (computer system) capable of achieving the state determination device 10 according to the first example embodiment or the state determination device 30 according to the second example embodiment of the present invention. That is, FIG. 7 illustrates a configuration of at least one computer (information processing device) capable of achieving the state determination devices 10 and 30 illustrated in FIGS. 1 and 6, and illustrates a hardware environment capable of achieving each function in the above-described example embodiments.

The information processing device 900 illustrated in FIG. 7 includes the following components as components, but may not include some of the following components.
CPU (Central Processing Unit) 901;
ROM (Read Only Memory) 902;
RAM (Random Access Memory) 903;
Hard disk (storage device) 904;
Communication interface 905 with an external device;
Bus 906 (communication line);
Reader/writer 908 capable of reading and writing data stored in recording medium 907 such as CD-ROM (Compact Disc Read Only Memory); and
Input/output interface 909 such as monitor, speaker, or keyboard.

That is, the information processing device 900 including the above-described components is a general computer to which these components are connected via the bus 906. The information processing device 900 may include a plurality of CPUs 901 or may include a CPU 901 configured by multiple cores. The information processing device 900 may include a graphical processing unit (GPU) (not illustrated) in addition to the CPU 901.

Then, the present invention described using the above-described example embodiment as an example supplies a computer program capable of achieving the following functions to the information processing device 900 illustrated in FIG. 7. The function is the above-described configuration in the block configuration diagram (FIGS. 1 and 6) referred to in the description of the example embodiment or the function of the flowchart (FIG. 5). Thereafter, the present invention is achieved by reading, interpreting, and executing the computer program on the CPU 901 of the hardware. The computer program supplied into the device may be stored in a readable/writable volatile memory (RAM 903) or a nonvolatile storage device such as the ROM 902 or the hard disk 904.

Furthermore, in the above case, a general procedure can be adopted at present as a method of supplying the computer program into the hardware. Examples of the procedure include a method of installing the program in the device via various recording media 907 such as a CD-ROM, a method of downloading the program from the outside via a communication line such as the Internet, and the like. In such a case, the present invention can be understood to be constituted by a code constituting the computer program or the recording medium 907 storing the code.

The present invention has been described above using the above-described example embodiments as exemplary examples. However, the present invention is not limited to the above-described example embodiments. That is, the present invention can apply various aspects that can be understood by those of ordinary skill in the art within the scope of the present invention.

### REFERENCE SIGNS LIST

10 State determination device
101 SAR observation data
102 Index data
11 Acquisition unit
12 Determination unit
13 Output unit
14 Generation unit
15 Storage unit
151 State measurement value
152 Calculation criterion
153 State estimation value
154 Criterion
155 Determination result information
20 Management terminal device
200 Display screen
30 State determination device
301 Observation information
31 Acquisition unit
311 State measurement value
32 Determination unit
321 Predetermined regularity
322 Index
323 State estimation value
33 Output unit
331 Determination result information
900 Information processing device
901 CPU
902 ROM
903 RAM
904 Hard disk (storage device)
905 Communication interface
906 Bus
907 Recording medium
908 Reader/writer
909 Input/output interface

What is claimed is:

1. A state determination device comprising:
at least one memory storing a computer program; and
at least one processor configured to execute the computer program to
acquire a state measurement value indicating a state of an area near an earth surface by analyzing observation information near the earth surface by a satellite-borne synthetic aperture radar;
determine whether a relationship between the state measurement value and a value of an index in which a predetermined regularity may exist between the index and the state or a relationship between the state measurement value and a state estimation value near the earth surface estimated from the value of the index satisfies the predetermined regularity; and
output determination result information indicating that the state is abnormal when the relationship between the value of the index and the state measurement value or the relationship between the state estimation value and the state measurement value does not satisfy the predetermined regularity.

2. The state determination device according to claim 1, wherein
the predetermined regularity indicates that at least one of a correlation, a linear relationship, and a relationship in which simulation of the state based on the index is possible is established between the index and the state.

3. The state determination device according to claim 1, wherein the processor is configured to execute the computer program to
calculate the state estimation value from the index using a calculation criterion indicating the predetermined regularity,
determine whether an absolute value of a difference between the state measurement value and the state estimation value is larger than a threshold, and
output the determination result information indicating that the state is abnormal when the absolute value is larger than the threshold.

4. The state determination device according to claim 3, wherein
the calculation criterion is an estimation model that has learned a relationship between the index and the state in the past.

5. The state determination device according to claim 4, wherein the processor is configured to execute the computer program to
generate or update the estimation model.

6. The state determination device according to claim 1, wherein
the state indicates a displacement amount of a ground surface near the earth surface or a position of a structure existing on the ground surface, or a moisture amount included in an earth surface near the earth surface.

7. The state determination device according to claim 1, wherein
the index indicates an elapsed time from a predetermined time.

8. The state determination device according to claim 1, wherein
the index indicates at least one of a natural factor and a human factor that affect the state,
the natural factor indicates at least one of a temperature, a precipitation amount, a groundwater amount, and a geological feature near the earth surface, and
the human factor indicates at least one of construction on the ground near the earth surface and a traffic volume near the earth surface.

9. A state determination method, the method causing an information processing device to execute:
acquiring a state measurement value indicating a state of an area near an earth surface by analyzing observation information near the earth surface by a satellite-borne synthetic aperture radar;
determining whether a relationship between the state measurement value and a value of an index in which a predetermined regularity may exist between the index and the state or a relationship between the state measurement value and a state estimation value near the earth surface estimated from the value of the index satisfies the predetermined regularity; and
outputting determination result information indicating that the state is abnormal when the relationship between the value of the index and the state measurement value or the relationship between the state estimation value and the state measurement value does not satisfy the predetermined regularity.

10. A non-transitory computer-readable recording medium storing a state determination program for causing a computer to execute:
an acquisition process of acquiring a state measurement value indicating a state of an area near an earth surface by analyzing observation information near the earth surface by a satellite-borne synthetic aperture radar;
a determination process of determining whether a relationship between the state measurement value and a value of an index in which a predetermined regularity may exist between the index and the state or a relationship between the state measurement value and a state estimation value near the earth surface estimated from the value of the index satisfies the predetermined regularity; and
an output process of outputting determination result information indicating that the state is abnormal when the relationship between the value of the index and the state measurement value or the relationship between the state estimation value and the state measurement value does not satisfy the predetermined regularity.

11. The state determination method according to claim 9, wherein
the predetermined regularity indicates that at least one of a correlation, a linear relationship, and a relationship in which simulation of the state based on the index is possible is established between the index and the state.

12. The state determination method according to claim 9, further comprising:
calculating the state estimation value from the index using a calculation criterion indicating the predetermined regularity;
determining whether an absolute value of a difference between the state measurement value and the state estimation value is larger than a threshold; and
outputting the determination result information indicating that the state is abnormal when the absolute value is larger than the threshold.

13. The state determination method according to claim 12, wherein
the calculation criterion is an estimation model that has learned a relationship between the index and the state in the past.

14. The state determination method according to claim 13, further comprising:
generating or update the estimation model.

15. The state determination method according to claim 9, wherein
the state indicates a displacement amount of a ground surface near the earth surface or a position of a structure existing on the ground surface, or a moisture amount included in an earth surface near the earth surface.

16. The non-transitory computer-readable recording medium according to claim 10, wherein
the predetermined regularity indicates that at least one of a correlation, a linear relationship, and a relationship in which simulation of the state based on the index is possible is established between the index and the state.

17. The non-transitory computer-readable recording medium according to claim 10, wherein the state determination program causes the computer to execute:
the determination process of calculating the state estimation value from the index using a calculation criterion indicating the predetermined regularity and determining whether an absolute value of a difference between the state measurement value and the state estimation value is larger than a threshold; and
the output process of outputting the determination result information indicating that the state is abnormal when the absolute value is larger than the threshold.

18. The non-transitory computer-readable recording medium to claim 17, wherein
the calculation criterion is an estimation model that has learned a relationship between the index and the state in the past.

19. The non-transitory computer-readable recording medium according to claim 18, wherein the state determination program causes the computer to execute
a generation process of generating or updating the estimation model.

20. The non-transitory computer-readable recording medium according to claim 10, wherein
the state indicates a displacement amount of a ground surface near the earth surface or a position of a structure existing on the ground surface, or a moisture amount included in an earth surface near the earth surface.
